(19) United States
(12) Patent Application Publication
(10) Pub. No.: US 2011/0238622 A1
(43) Pub. Date: Sep. 29, 2011

(54) SYSTEM, METHOD AND COMPUTER PROGRAM PRODUCT FOR ASSOCIATING A RECORD WITH AN ACCOUNT FROM AN ON-DEMAND DATABASE SYSTEM

(75) Inventors: Jeanine Walters, San Francisco, CA (US); Pratima Arora, Sunnyvale, CA (US); Don C. Jay, San Francisco, CA (US); Herman Kwong, Danville, CA (US); John Liang, Castro Valley, CA (US); Yuan (Peter) Wang, Alameda, CA (US); Rachna Singh, Foster City, CA (US); Lu Ping Chen, Oakland, CA (US); Frank Lopez, San Francisco, CA (US)

(73) Assignee: SALESFORCE.COM, INC., San Francisco, CA (US)

(21) Appl. No.: 12/949,723

(22) Filed: Nov. 18, 2010

Related U.S. Application Data
(60) Provisional application No. 61/318,204, filed on Mar. 26, 2010.

(51) Int. Cl. G06F 17/30

(52) U.S. Cl. 707/610; 707/769; 707/E17.005; 707/E17.014

(57) ABSTRACT

In accordance with embodiments, there are provided mechanisms and methods for associating a record with an account from an on-demand database system. These mechanisms and methods for associating a record with an account from an on-demand database system can enable improved synchronization between an on-demand database system and a software element separate from the on-demand database system, etc.

### CLAIM OF PRIORITY

This application claims the benefit of U.S. Provisional Patent Application 61/318,204, entitled “Contact Matching API to Control Contact Sync,” by Walters et al., filed Mar. 26, 2010 (Attorney Docket No. SFC1P097+/185PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to synchronizing data, and more particularly to synchronizing data between different applications.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In conventional on-demand database systems, it may be desirable to synchronize an on-demand database system with another software element. For example, a user of a software element separate from the on-demand database system may wish to have data from the software element available in the on-demand database system. Unfortunately, conventional synchronization systems have been associated with various limitations.

Just by way of example, traditional methods of synchronizing an on-demand database system with another software element may involve significant user interaction. For instance, a user of a software element that synchronizes the software element with an on-demand database system may be forced to make many manual synchronization decisions during the synchronization of data between the software element and the on-demand database system. Accordingly, it is desirable to provide techniques that improve synchronization between an on-demand database system and a software element separate from the on-demand database system.

### BRIEF SUMMARY

In accordance with embodiments, there are provided mechanisms and methods for associating a record with an account from an on-demand database system. These mechanisms and methods for associating a record with an account from an on-demand database system can enable improved synchronization between an on-demand database system and a software element separate from the on-demand database system, etc.

In an embodiment and by way of example, a method for associating a record with an account from an on-demand database system is provided. In one embodiment, a record is identified from a first source. Additionally, a first aspect of the record is identified from the first source. Further, the first aspect of the record from the first source is matched with a first aspect of a record from an on-demand database system. Further still, a second aspect of the record is identified from the first source. Additionally, the second aspect of the record from the first source is matched with a second aspect of the record from the on-demand database system. Also, the record from the first source is associated with the record from the on-demand database system based on the matching of the first aspect and the matching of the second aspect.

While one or more implementations and techniques are described with reference to an embodiment in which enabling an aspect required with respect to code to be installed within an on-demand database system (e.g., a multi-tenant on-demand database system, etc.) is implemented in a system having an application server providing a front end for an on-demand database system (where in one embodiment, the system is capable of supporting multiple tenants), the one or more implementations and techniques are not limited to databases (e.g., multi-tenant databases, etc.) nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for associating a record with an account from an on-demand database system, in accordance with one embodiment;

FIG. 2 illustrates a method for performing a contact synchronization sequence, in accordance with another embodiment;

FIG. 3 illustrates a method for performing contact matching and association, in accordance with yet another embodiment;

FIG. 4 illustrates a method for performing detailed contact matching and association, in accordance with one embodiment;

FIG. 5 illustrates a block diagram of an example of an environment wherein an On-demand database system might be used; and

FIG. 6 illustrates a block diagram of an embodiment of elements of FIG. 5 and various possible interconnections between these elements.

### DETAILED DESCRIPTION

### General Overview

Systems and methods are provided for associating a record with an account from an on-demand database system.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers.

Next, mechanisms and methods for associating a record with an account from an on-demand database system will be described with reference to example embodiments.

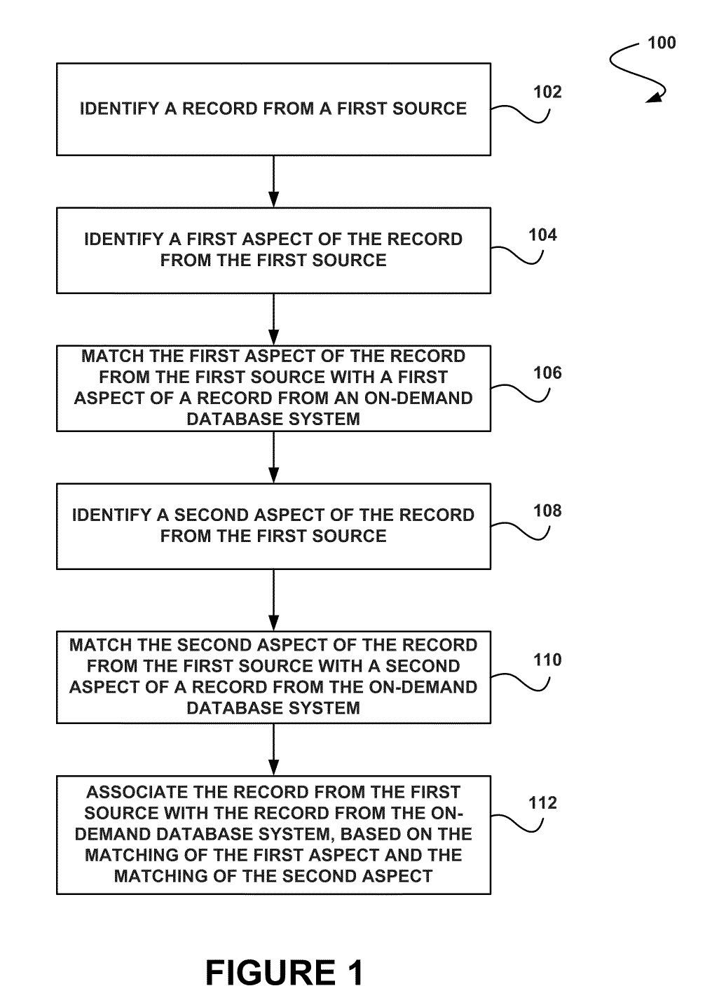

FIG. 1 illustrates a method 100 for associating a record with an account from an on-demand database system, in accordance with one embodiment. As shown in operation 102, a record is identified from a first source. In one embodiment, the first source may include a software application. For example, the first source may include an electronic mail message application, a personal information manager application, a calendar application, a task application, etc. In another embodiment, the record may include one or more instances of data associated with the first source (e.g., stored in the first source, utilized by the first source, etc.). For example, the record may include a contact, an event, an account, an electronic mail message, a task, a custom object, etc. In yet another embodiment, a plurality of records may be associated with the first source.

Additionally, in one embodiment, the record may be identified as a result of one or more events. For example, the record may be identified as the result of an attempt to synchronize the first source with an on-demand database system. In another embodiment, the record may be sent by the first source. In yet another embodiment, the record may be extracted from the first source. Of course, however, the record may be identified from the first source in any manner.

It should be noted that, as described above, such on-demand database system (e.g., a multi-tenant on-demand database system, etc.) may include any service that relies on a database system that is accessible over a network, in which various elements of hardware and software of the database system may be shared by one or more customers (e.g. tenants). For instance, a given application server may simultaneously process requests for a great number of customers, and a given database table may store rows for a potentially much greater number of customers. Various examples of such a multi-tenant on-demand database system will be set forth in the context of different embodiments that will be described during reference to subsequent figures.

Further, as shown in operation 104, a first aspect of the record is identified from the first source. In one embodiment, an aspect may include a field, value, etc. associated with the record (e.g., a value located within the record, etc.). For example, the aspect may include an electronic mail address associated with the record, a first name associated with the record, a last name associated with the record, a company associated with the record, etc. In another embodiment, the first aspect may be determined by the on-demand database system, by a user, by an administrator, etc.

Further still, as shown in operation 106, the first aspect of the record from the first source is matched with a first aspect of a record from an on-demand database system. In one embodiment, the record from the on-demand database system may include one or more instances of data associated with on-demand database system (e.g., stored in the on-demand database system, utilized by the on-demand database system, etc.). In another embodiment, matching the first aspect of the record from the first source with the first aspect of the record from the on-demand database system may include comparing the first aspect of the record from the first source against a plurality of aspects of a plurality of records from the on-demand database system, and determining whether one or more matches are found. Additionally, in one embodiment, the matching may include soft/fuzzy matching. For example, matches may be determined based on close, but not exact, matches between records of the first source and the on-demand database system.

In yet another embodiment, the matching may be performed using pre-defined matching criteria. In one embodiment, such criteria may be determined by the on-demand database system. In another embodiment, the criteria may be determined by a user. Additionally, in one embodiment, matching the first aspect of the record from the first source with the first aspect of the record from an on-demand database system may result in a single match (e.g., a single record), a plurality of matches (e.g., a plurality of records), or no matches. In yet another embodiment, if the matching results in a plurality of matches, the first aspect may be sent to a queue where a manual decision regarding the preferred match may be made.

In another embodiment, if the matching results in a plurality of matches, a preferred match may be made automatically, based on one or more criteria (e.g., the last modified aspect in the on-demand database system, the aspect in which a user last logged activity in the on-demand database system, the oldest aspect in the on-demand database system, etc.). In yet another embodiment, the criteria may include user criteria (e.g., criteria input by the user into the on-demand database system, etc.).

Also, as shown in operation 108, a second aspect of the record is identified from the first source. In one embodiment, the second aspect may be determined by the on-demand database system, by a user, by an administrator, etc. In addition, as shown in operation 110, the second aspect of the record from the first source is matched with a second aspect of the record from the on-demand database system. In one embodiment, the matching may include comparing the second aspect of the record from the first source against a plurality of aspects of a plurality of records from the on-demand database system, and determining whether one or more matches are found. In another embodiment, one or more additional aspects of the record from the first source may be matched to one or more aspects of the record from the on-demand database system in addition to the second aspect. In yet another embodiment, a plurality of aspects of the record may be identified and matched with a plurality of aspects of the record from the on-demand database system (e.g., a first and last name, a name and an electronic mail address, etc.).

In yet another embodiment, matching the second aspect of the record from the first source with the second aspect of the record from the on-demand database system may result in a single match (e.g., a single record), a plurality of matches (e.g., a plurality of records), or no matches. Additionally, in one embodiment, if the matching results in a plurality of matching records, a single record may be determined as a match from the plurality of matching records, based on one or more criteria. For example, the single record may be automatically determined based on one or more user preferences. In another example, if one of the plurality of matching records has a matching account associated with the second aspect, then that record may be preemptively chosen. In yet another example, the record from the first source may be added to a queue (e.g., an unresolved items queue), and a user may access the queue and manually determine the match from the plurality of matching records.

Furthermore, as shown in operation 112, the record from the first source is associated with the record from the on-demand database system based on the matching of the first aspect and the matching of the second aspect. For example, associating the record from the first source with the record from the on-demand database system may include linking the record from the first source to the record from the on-demand database system based on the matching of the first aspect and the matching of the second aspect. In one embodiment, the record from the on-demand database system may be associated with an account of the on-demand database system. For example, the record from the on-demand database system may be found within the account of the on-demand database system. In another embodiment, the account of the on-demand database system may be associated with an entity. For example, the account may be linked to a company, an individual (e.g., a user, a developer, etc.), etc.

Additionally, in one embodiment, the second aspect of the record may not be identified from the first source and may not be matched with a second aspect of the record from the on-demand database system if matching the first aspect of the record from the first source with the first aspect of the record from the on-demand database system results in a single match. For example, if matching the first aspect of the record from the first source with the first aspect of the record from the on-demand database system results in a single match, the record from the first source may be automatically associated with the account from the on-demand database system, based on the matching of the first aspect.

Further, in another embodiment, a new record may be created in the on-demand database system. For example, if matching the first aspect of the record and matching the second aspect of the record results in no matches, a new record may be created in the on-demand database system, and such new record may be associated with the record from the first source. In another embodiment, the new record may be created automatically. In yet another embodiment, the record from the first source may be added to a queue (e.g., an unresolved items queue), and a user may access the queue and manually create the new record.

In this way, progressive multi-step matching of the record may be performed between the first source and the on-demand database system. Additionally, the matching and associating may be performed automatically (e.g., without the need for user input), and may be performed on an on-demand database system. Further, in one embodiment, the outcome of the multi-step matching may be configurable (e.g., by a user, etc.). For example, a user may determine an action to take upon particular criteria being met during the matching of the first and second aspects, may determine the criteria, etc.

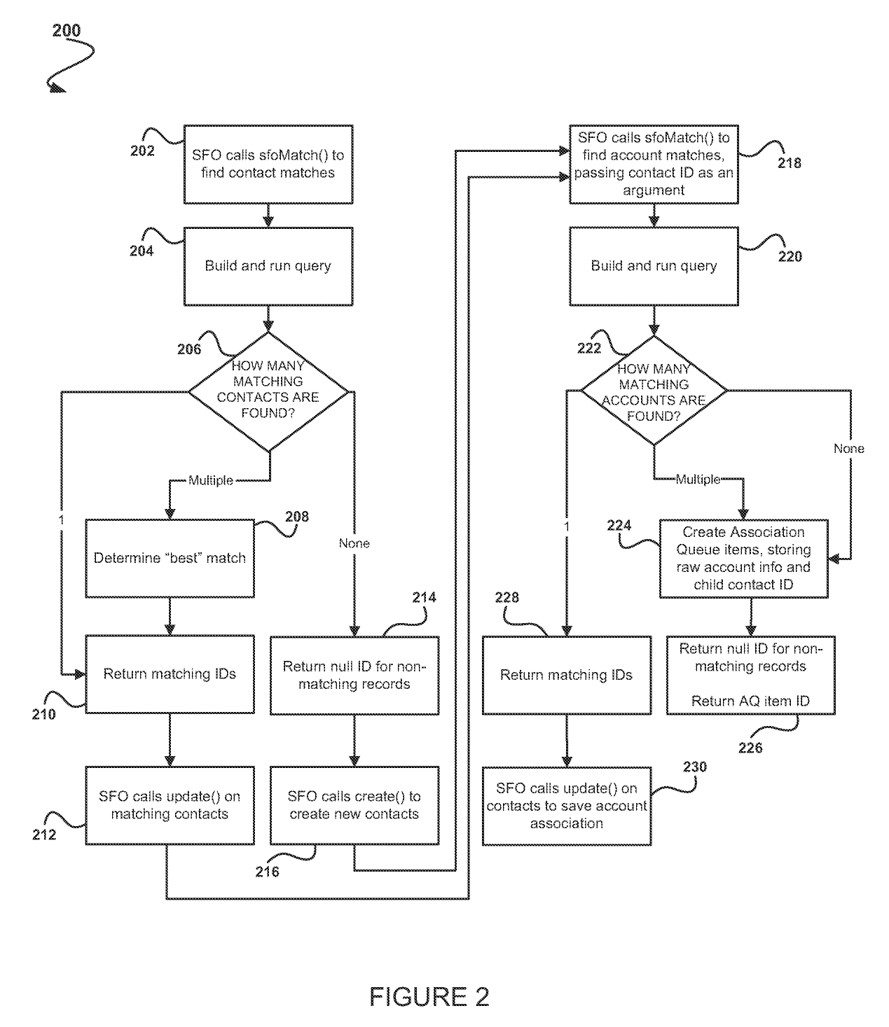

FIG. 2 illustrates a method 200 for performing a contact synchronization sequence, in accordance with another embodiment. As an option, the present method 200 may be carried out in the context of the functionality of FIG. 1. Of course, however, the method 200 may be carried out in any desired environment. The aforementioned definitions may apply during the present description.

As shown in operation 202, a Microsoft Outlook® personal information manager sync client (SFO) calls an application programming interface (API) operation sfoMatch( ) in order to find contact matches. In one embodiment, sfoMatch( ) may facilitate the lookup for both contacts and accounts in a sync cycle. Additionally, as shown in operation 204, a query is built and run. Further, as shown in decision 206, the number of matching contacts is determined.

If in decision 206 it is determined that multiple matching contacts are found, then in operation 208 a single best match is determined. In one embodiment, the best match may be determined based on one or more predetermined criteria (e.g., user input conditions, default criteria, etc.). Additionally, as shown in operation 210, the IDs matching the best match are then returned. If in decision 206 it is determined that a single matching contact is found, then in operation 210 the IDs matching the single matching contact are returned. Further, as shown in operation 212, the sync client calls an update function on the matching contacts.

If in decision 206 it is determined that no matching contacts are found, then in operation 214 a null ID is returned for non-matching records. Additionally, as shown in operation 216, the sync client calls a create function to create new contacts. Further, as shown in operation 218, the sync client calls sfoMatch( ) in order to find account matches, and passes the matching contact ID as an argument. Further still, as shown in operation 220, a query is built and run.

Also, as shown in decision 222, the number of matching accounts is determined. If in decision 222 it is determined that multiple matching accounts are found, or that no matching accounts are found, then in operation 224 associating queue items are created, and raw account information and a child contact ID are stored. Additionally, as shown in operation 226, a null ID is returned for non-matching records, and an AQ item ID is returned. If in decision 222 it is determined that a single matching account is found, then in operation 224, then as shown in operation 228 the matching IDs are returned, and as shown in operation 230, the sync client calls an update function on the contacts to save the account association.

In one embodiment, a contact in an external system (for example, Outlook or another source may be matched to a contact in an on-demand database service, and that contact may be associated to an account. Contact syncing from the Outlook sync client (SFO), or other clients like GMail, Exchange, etc. may be provided. In another embodiment, SR) may retrieve contacts from the on-demand database service via an asynchronous data cache. This feature may focus on one or more operations involved in uploading contacts from Outlook to the on-demand database service.

Additionally, in one embodiment, contact matching may involve finding contacts on the on-demand database service through pre-defined matching criteria. If an email address is specified on the external system contact, matching may be driven by the email field. In another embodiment, matching may be performed with a combination of first name, last name, and company fields. In yet another embodiment, all matches may have to be exact. In still another embodiment, if multiple matching contacts are found, the “best” match may be returned. For example, a “best” match may include the more recently modified contact. In another embodiment, what constitutes a “best” match (for example, the most recently modified) may be configurable.

Further, in one embodiment, account association may involve assigning contacts to appropriate accounts. For example, a matching account may be found when the account name of the on-demand database service is the same as the company value in the external system contact. In another embodiment, if an exact match is not found, or if there are multiple matches, an item may be added to an association queue for the user to later resolve. Additionally, see, for example, U.S. patent application Ser. No. 12/879,222, Attorney Docket Number 155US, filed Sep. 10, 2010, which is hereby incorporated by reference in its entirety, and which describes an exemplary association queue.

Further still, in one embodiment, the sfoMatch( ) API operation may look up on-demand database service records that match with the inputs. In another embodiment, the match-fields may be determined by entity hook overrides. In yet another embodiment, lookups may be performed in bulk. Also, in another embodiment, the new API operation may be in a private WSDL.

In addition, in one embodiment, the sfoMatch( ) sequence may proceed as follows: (1) retrieve match-fields from entity hook; (2) retrieve match-field values from API input; (3) build and run query to find matching records; (4) generate and return results, where unique matches are put in a result set, no matches results in the creation of an association queue item if aqParentIds are specified, and multiple matches results in the creation of an association queue item if aqParentIds are specified, or the picking of a “best” match.

Table 1 illustrates one example of an sfoMatch( ) API definition. Of course, it should be noted that the definition shown in Table 1 is set forth for illustrative purposes only, and thus should not be construed as limiting in any manner.

TABLE 1

| Arguments | | |
|---|---|---|
| Name | Type | Description |
| sObjects | sObjects[ ] | Array of objects (contacts and/or |
| | | accounts only in 164) to upload |
| | | (maximum 200) |
| aqParentIds | ID[ ] | Parent record IDs for creating |
| | | Association Queue items |
| Response | | |
| SfoMatchResult[ ] | | |
| SfoMatchResult | | |
| Name | Type | Description |
| id | ID | ID of Salesforce record matched |
| associationQueueItemId | ID | ID of any Association Queue |
| | | Items created |
| success | Boolean | Like upsert (in the context of a |
| | | multi-tenant on-demand database |
| | | system web service API), if |
| | | there're errors on the record, |
| | | this'd be false, otherwise true. |
| | | Having a success flag is standard |
| | | sfdc api behavior. |
| errors | Error[ ] | Errors |

Faults
INVALID_ID_FIELD exception unless the sObjects are Contacts,
Accounts, or Events
UNKNOWN_EXCEPTION exception unless client ID starts with
“OutlookSync/”.
Using UNKNOWN_EXCEPTION instead of SUPPORTED_CLIENT
to add obscurity to this undocumented API.
INVALID_TYPE exception if sObjects of different types are sent in the
same call
Other potential access exceptions

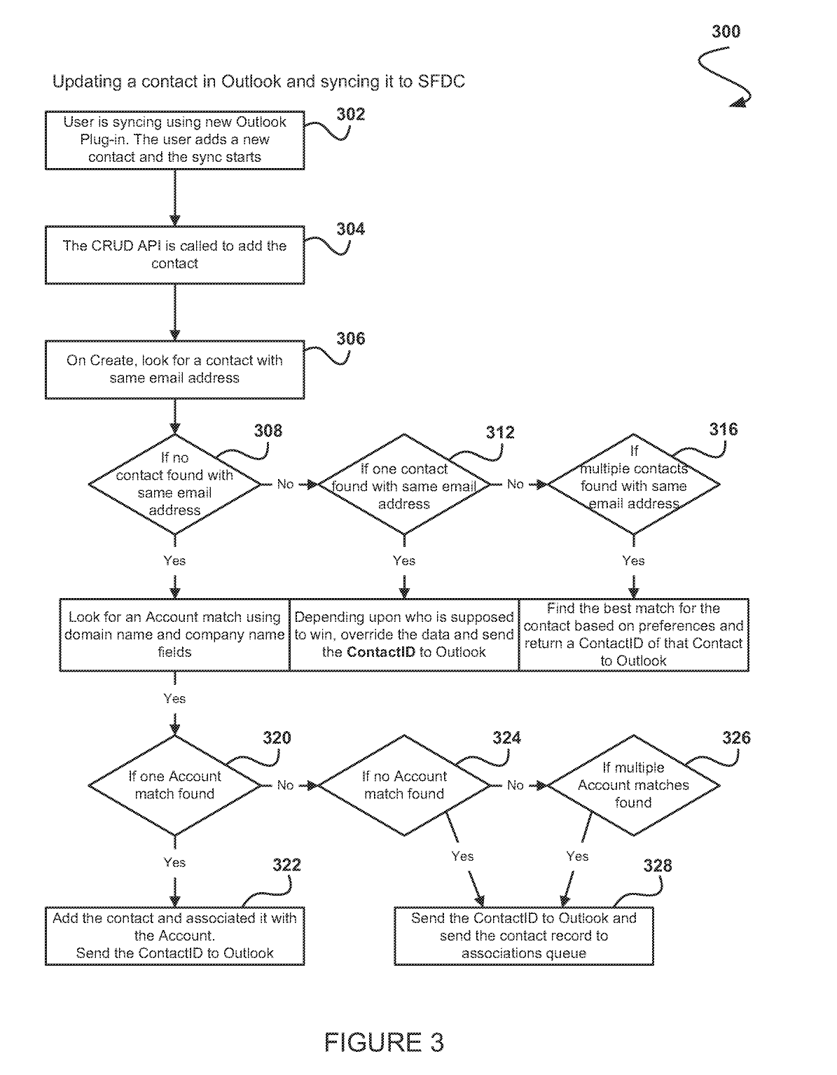

FIG. 3 illustrates a method 300 for performing contact matching and association, in accordance with yet another embodiment. As an option, the present method 300 may be carried out in the context of the functionality of FIGS. 1-2. Of course, however, the method 300 may be carried out in any desired environment. Again, the aforementioned definitions may apply during the present description.

As shown in operation 302, it is determined that a user is syncing using a new Outlook Plug-in, that the user adds a new contact, and that the sync starts. Additionally, as shown in operation 304, the CRUD API is called to add the contact. Further, as shown in operation 306, on create, a contact with the same email address is searched for. Further still, as shown in decision 308, it is determined whether no contact is found with the same email address.

If it is determined in decision 308 that at least one contact is found with the same email address, then in decision 312 it is determined whether a single contact is found with the same email address. If it is determined in decision 312 that a single contact is found with the same email address, then in operation 314, depending on who is supposed to win, the data is overridden and the contact ID is sent to an Outlook plug-in. If it is determined in decision 312 that a single contact is not found with the same email address, then in decision 316 it is determined whether multiple contacts are found with the same email address.

If it is determined in decision 316 that multiple contacts are found with the same email address, then in operation 318, the best match for the contact is determined based on one or more preferences, and a contact ID of that contact is returned to the Outlook plug-in. Additionally, if it is determined in decision 308 that no contact is found with the same email address, then in operation 310, an account match is searched for using domain name and company name fields. Further, in decision 320, it is determined if a single account match is found. If it is determined in decision 320 that a single account match is found, then in operation 322, the contact is added and associated with the account, and the contact ID is sent to the Outlook plug-in.

If it is determined in decision 320 that a single account match is not found, then in decision 324 it is determined whether no account match is found. If in decision 324 it is determined that at least one account match is found, then in decision 326 it is determined whether multiple accounts are found. If in decision 324 it is determined that no account match is found, or if in decision 326 it is determined that multiple account matches are found, then in operation 328 the contact ID is sent to the Outlook plug-in and the contact record is sent to the associations queue. Additionally, an association queue ID may be sent to the Outlook plug-in.

In one embodiment, contact matching and associations may help users match a contact from a first source to one in the on-demand database system and also associate that contact to an account. In another embodiment, it may support contacts syncing from an Outlook plug-in or for any email client or server like gmail, exchange, etc.

In yet another embodiment, the matching and associations of the contacts may happen in the cloud. So the Plug-in may send all the contacts that were synchronized through the API to the on-demand database system. The new matching and associations algorithm may match and associate outlook contacts with existing records where a contact is found, or create new ones as appropriate.

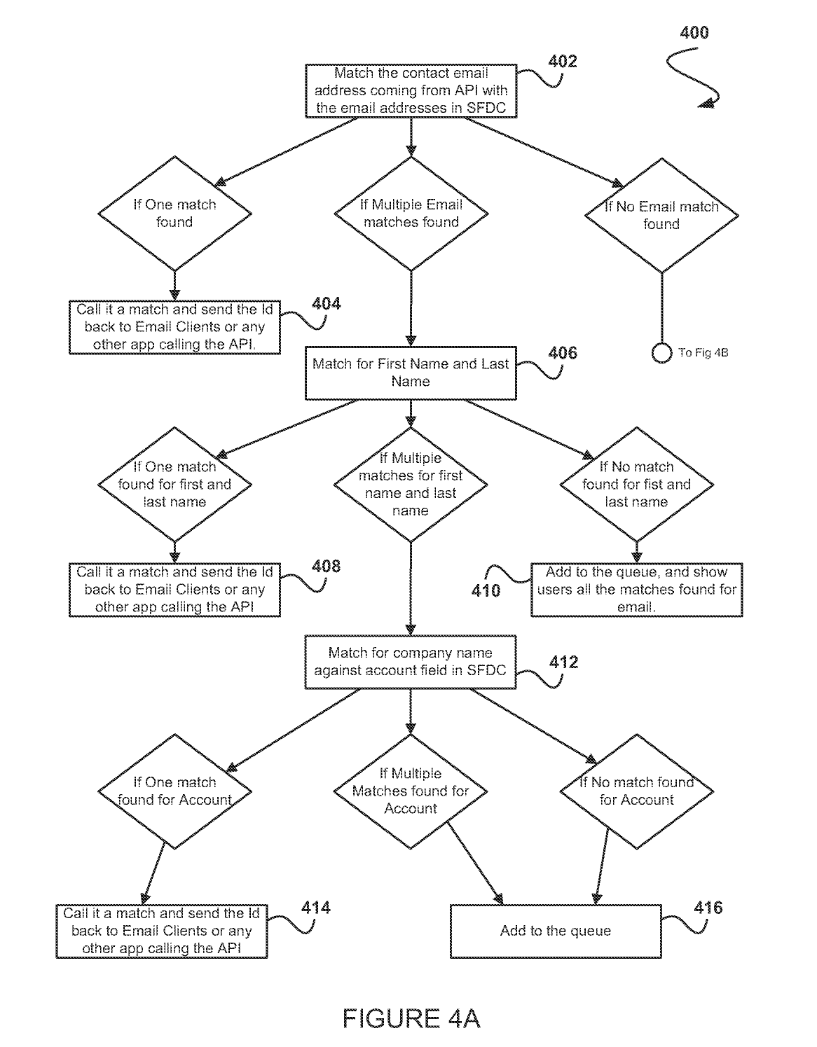

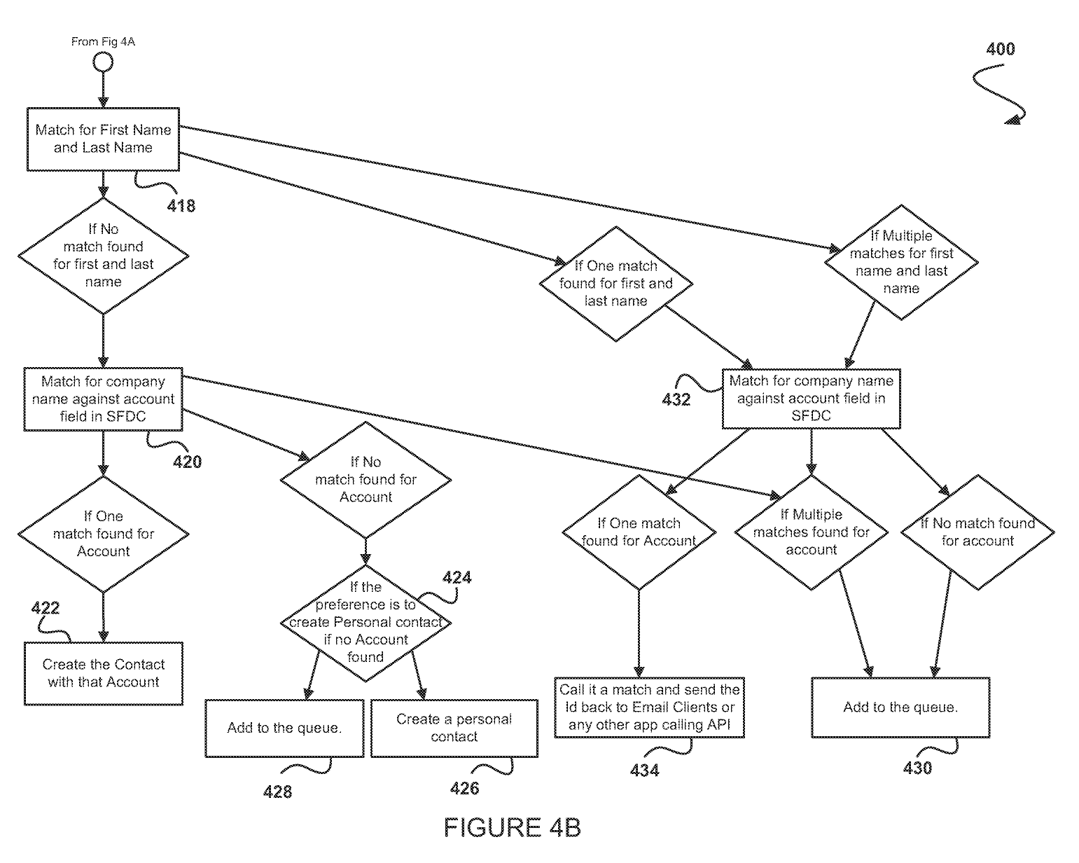

FIG. 4 illustrates a method 400 for performing detailed contact matching and association, in accordance with yet another embodiment. As an option, the present method 400 may be carried out in the context of the functionality of FIGS. 1-3. Of course, however, the method 400 may be carried out in any desired environment. Again, the aforementioned definitions may apply during the present description.

As shown in operation 402, a contact email address of a record of a client (e.g., an email client, client from a first source, etc.) coming from an API, (e.g., an API of the on-demand database system) is matched with the email addresses of records in an on-demand database system, and a number of matches are determined. In one embodiment, a contact may be created in the client that has an email address. If it is determined in operation 402 that one match is found, then in operation 404, a match is declared and the ID of the match is sent back to the email client or any other app calling the API. If in operation 402 it is determined that multiple email matches are found (e.g., multiple contacts in the on-demand database have the same email address as the record of the client), then in operation 406 a first name and a last name associated with the record are matched with first and last names of records in the on-demand database system.

Additionally, if it is determined in operation 406 that one match is found for the first and last name associated with the record, then in operation 408 a match is declared and the ID of the match is sent back to the email client or any other app calling the API. Further, if it is determined in operation 406 that no match is found for the first and last name associated with the record, then in operation 410 the record is added to the queue and a user is shown all matches for the record. Alternately, an automatic decision may be made (and a match chosen) based on one or more user preferences (e.g., preferences selected in the on-demand database system).

Further still, if it is determined in operation 406 that multiple matches are found for the first and last name associated with the record, then in operation 412 a company name associated with the record is matched against an account field in the on-demand database system. Alternately, one contact may be chosen based on one or more user preferences (e.g., preferences selected in the on-demand database system). Also, if one matching account field is determined in operation 412, then in operation 414 a match is declared and the ID of the match is sent back to the email client or any other app calling the API. If multiple matching account fields or no matching account fields are determined in operation 412, then in operation 416 the record is added to the queue.

If in operation 402 is determined that no email matches are found, then in operation 418 a first name and a last name associated with the record are matched with first and last names of records in the on-demand database system. Additionally, if it is determined in operation 418 that no match is found for the first and last name associated with the record, then in operation 420 a company name associated with the record is matched against an account field in the on-demand database system.

Further, if one matching account field is determined in operation 420, then in operation 422 a contact is created with that account. Further still, if no matching account fields are determined in operation 420, then in decision 424 it is determined whether a preference (e.g., a user preference, a predetermined preference, a default preference, etc.) includes creating a personal contact if no account is found. If in decision 424 it is determined that the preference is to create a personal contact, then in operation 426 a personal contact is created. If in decision 424 it is determined that the preference is not to create a personal contact, then in operation 428 the record is added to the queue. Also, if multiple matching account fields are determined in operation 420, then in operation 430 the record is added to the queue.

In addition, if it is determined in operation 418 that one or more matches are found for the first and last name associated with the record, then in operation 432 a company name associated with the record is matched against an account field in the on-demand database system. Further, if one matching account field is determined in operation 432, then in operation 434 a match is declared and the ID of the match is sent back to the email client or any other app calling the API. If multiple matching account fields or no matching account fields are determined in operation 432, then in operation 430 the record is added to the queue.

In one embodiment, on the first time sync between the on-demand database system and the first source, contact matching may be done on records based on the email address (first name, last name, company, all or a combination), for example, as follows: (1.) If the system finds a contact that the user has visibility into with same email address (first name, last name and company; all or a combination), the contact may be matched and synced to that record. (2.) If no contact is found, the system may create a contact (personal or business depending upon the associations logic and their preference) and may return an Id to the first source. (3.) When multiple contacts are found, we may pick one right contact based on the preferences i.e.: (A) Match with the most recently updated contact, (B) Match with the contact with most no. of activities or most recent Last Activity Date. Customers may not be prompted every time to take an action if a dupe was found. As an enhancement, they may be able to review and change the matching.

In this way, one or more items may be resolved. For example, we may always send one matching contactID back to the first source (e.g., outlook, etc.), resulting in less ambiguity. Additionally, we may not have an exception list or unresolved contacts state in the queue. Further, the queue may become a pure associations queue and users may not be given an option to pick the right contact they want to match. Further still, we may not solve for the case where duplicates are created in outlook because they existed in SFDC. For example, if a record exists in SFDC and it is part of the Outlook data set, a user may get that contact in Outlook.

In another embodiment, one or more items may be handled on the source side (e.g., outlook, etc.). For example, the matching algorithm may return the best matched ID found, and it may not distinguish if the that ID was already matched with something in Outlook or not. Outlook may handle that case, if it's a priority. In another example, we may return an error message with all the matched ID's if Outlook wants that. In another example, when SFDC wins, we may return an ID, and Outlook may need to retrieve the data from SFDC.

In yet another example, Outlook may need to decide whether they want to sync up first or do a retrieve first in the first time sync scenario. In one embodiment, for first time sync, Outlook may just send the records up first and retrieve ID's back for the matched records. And the sync down, and create new contacts in outlook where there is no match in the matching table. In another embodiment, for on-going sync, if new records are created in SFDC, an email clients team may take care of the matching for that record on the Outlook Side (if a priority for them).

Additionally, in another embodiment, current matching may be on static matching algorithm that users can't update, though we may read the field mappings from the Outlook Plug-in configurations, so that we may pick the right mapping especially for Email address field which could be any of the 3 email fields in Outlook. In yet another embodiment, outlook may choose the correct Email address field when they call Upsert.

Further, in one embodiment, with respect to on-going sync and updates, if a user modifies a record in Outlook or the on-demand database system that is already being synced in the past, the changes may sync to the other system without creating duplicates. In another embodiment, when a new contact is added, it may follow the same process as first time sync, the system may try to match it against the contacts it has read/write access to and if a match is found, the contact may be mapped to that contact otherwise a new contact is created and handed over to associations logic for more action. In another embodiment, if multiple contacts are found, we may pick the right match based on the preference. In yet another embodiment, no matching logic may run on updates as the records are already matched, but there may be associations logic that may run if user modifies company name or email address on Outlook side.

Further still, in another embodiment, one or more matching embodiments may be enabled. For example, fuzzy matching may be performed (e.g., matching of “Yahoo Inc,” with “yahoo,” etc.). In another example, customization of matching fields may be performed. For example, new fields may be added and fields may be removed from the matching algorithm. In yet another example, there may be a way for user to revert the matching if they don't agree with it and create a new match. In still another example, contact owners may verify all the record updates that happen on the contacts they own, and may revert back any changes if they don't agree with it. (e.g., basically creating some sort of history or audit trail, etc.).

Also, in yet another embodiment, during a first type sync, when no contact is found, for contacts where a single account is found based on the domain name (from the email address) or company name, the contact may be created and associated automatically. Additionally, for contacts where no account is found, they may be sent to an associations queue (e.g., by default, etc.). Additionally, the contact may be added as a personal contact or a person account (e.g., a user setting, etc.). Further, for contacts where multiple accounts are found, the contact may be sent to the associations queue. Further still, a personal contact may be created.

In another embodiment, when multiple contacts are found, the contact may be sent to an associations queue (e.g., by default, etc.). Additionally, the contact may be synced with the contact record in the on-demand database system with most activities (e.g., a user setting, etc.) (P2). In yet another embodiment, till the user makes a decision in the associations queue, we may need to map the Outlook contact with a SFDC contact. This may be necessary so that we don't lose updates, i.e. if there are any updates to the contact in Outlook while it is still in associations queue, those updates should sync up to SFDC as well. We may either match it to a contact with most activities or create another record that is matched to the record in outlook. And if the user chooses one of the existing contacts, we may do a merge. Further, in another embodiment, a personal contact may be created.

In yet another embodiment, when all contacts are person accounts, all contacts may be automatically created as person accounts with no association (this may be a user/admin preference again) (P2, will be a P1 if Email Clients team implements Person accounts). Additionally, in another embodiment, when all contacts are personal contacts, all contacts may be automatically created as personal contacts with no associations (this may be a user/admin preference again).

Further, in another embodiment, users may view the associations queue on an associations screen and take the following actions. Users may be able to associate contacts to an account. The account name may be pre-populated if we can figure it out using email domain name or company name. Users may be able to create new Accounts if Accounts don't exist. If duplicate contacts are found, users may map this contact with one of the SFDC contacts or create a new one. There may be an option to merge contacts as well (P2). Users may be able to take bulk actions. Users may be able to delete contacts in bulk. Contacts may be made personal or saved as person accounts. Contacts may be associated to one account. Role Hierarchy Association (P3) may be performed (e.g., “Reports To,” etc.). Further, contact information besides name, email address and account may be previewed. (P2).

In another embodiment, with respect to on-going sync, if a contact record is modified in Outlook and the company or email address field is changed that maps to on-demand database system account field, the Outlook. Plug-in may mark that record so that next time the sync happens, we may run the associations logic so that the new company name is matched to the right Account, (P2). In yet another embodiment, if the contact is in the associations queue, and the user updates the record in Outlook, all the changes may be refreshed in the contact record in associations queue. If all the open questions for associations are answered, the record may vanish from the associations queue. This refresh may happen any time, but at the latest at the time of loading of associations queue.

Further still, in one embodiment, with respect to user and administrator settings, automatic associations may be optionally turned on/off (e.g., we may use Outlook Plug-in preference here). Additionally, with respect to Optional Conflict Resolution for first time sync, SFDC may win, or Outlook may win. Further, when multiple contacts are found, they may be part of a configuration schema and may be exposed to both Admin and User. Further still, there may be an option for the adjoin if they want to expose it to user or not, and user setting always trumps admin setting. In one embodiment, the contact may be matched with the or most recent activity (e.g., by default, etc.). In another embodiment, the contact may be matched with that most recently updated updates. In yet another embodiment, the oldest record may be matched. In still another embodiment, the match may occur where I am the owner (e.g., may default to most recent activity if there is a conflict). In another embodiment, the owner highest in role hierarchy (P3) may be matched.

Also, in one embodiment, when no account is found, it may be part of the configuration schema and may be exposed to both Admin and User. There may be an option for an admin if they want to expose it to user or not, and user setting always trumps admin setting. In one embodiment, the contact may be Added to the association queue (AQ). In another embodiment, the contact may be kept as private contact and may not be added to the AQ. In yet another embodiment, the account may be created and may be associated to the contact automatically.

In another embodiment, with respect to reporting/list views and searching, reports may act no differently. For example, users may be able to report on contacts. In one embodiment, an optional other list view/report may exist for not associated contacts or associated contacts (e.g. contacts that were associated properly, etc.) (P3).

Additionally, in one embodiment, with respect to security, we may only try to match contacts against the records users have visibility into. For example, if we have a contact that user has read permissions but not write permissions, and if the user setting is to update the record with Outlook data, we may treat it as a no contact found, or may send it to associations queue.

Further, in another embodiment, with respect to the refresh of data, when a contact is in the associations queue and the record gets updated by either other users or Outlook plug-in, the following may optionally occur. If the updates are to fields that we don't show in associations queue, we may not worry about them. If the updates are to the fields that show up on the associations screen, we may refresh those fields in the associations queue when user accesses the associations screen. For example, if the first name or last name gets updates, the updated information may show up in the queue. If the user updates the company from IBM to Equinox, our associations logic may show appropriate results (e.g., if we were able to find equinox nor not and if multiple account matches were found, etc.). If one account match was found, the contact may vanish from the associations queue. Further, if a user updates an email address, the associations logic may re-run to show the updated information on the screen.

In another embodiment, while the user is working on the queue, we may refresh the queue (e.g., after every action on the screen, etc.) (P2). If a user creates an account in a previous row for IBM and the next contact on the list has an email address of something@ibm.com, we may recommend IBM as an account match for this new contact. If we don't implement this, the work around may be that on the next row, the user may have to do an account lookup and find IBM. Also, if the user leaves the screen and makes an update to the contact from another screen, then the user would have to hit browser refresh to see the new updates on the associations screen.

### System Overview

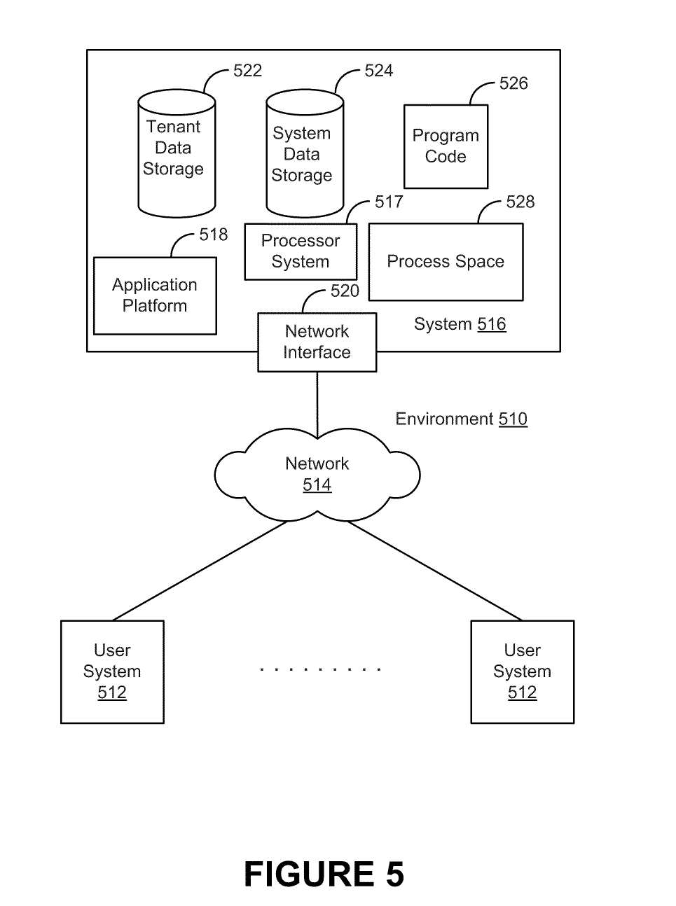

FIG. 5 illustrates a block diagram of an environment 510 wherein an on-demand database system might be used. Environment 510 may include user systems 512, network 514, system 516, processor system 517, application platform 518, network interface 520, tenant data storage 522, system data storage 524, program code 526, and process space 528. In other embodiments, environment 10 may not have all of the components listed and/or may have other elements instead of, or in addition to, those listed above.

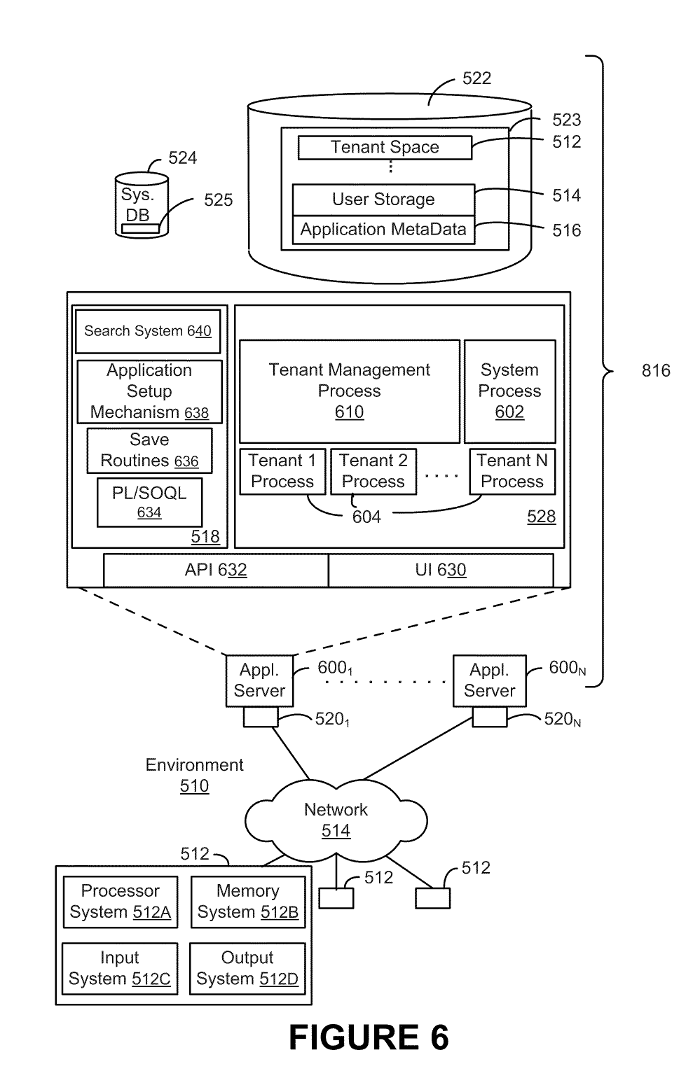

Environment 510 is an environment in which an on-demand database system exists. User system 512 may be any machine or system that is used by a user to access a database user system. For example, any of user systems 512 can be a handheld computing device, a mobile phone, a laptop computer, a work station, and/or a network of computing devices. As illustrated in FIG. 5 (and in more detail in FIG. 6) user systems 512 might interact via a network 514 with an on-demand database system, which is system 516.

An on-demand database system, such as system 516, is a database system that is made available to outside users that do not need to necessarily be concerned with building and/or maintaining the database system, but instead may be available for their use when the users need the database system (e.g., on the demand of the users). Some on-demand database systems may store information from one or more tenants stored into tables of a common database image to form a multi-tenant database system (MTS). Accordingly, “on-demand database system 516” and “system 516” will be used interchangeably herein. A database image may include one or more database objects. A relational database management system (RDMS) or the equivalent may execute storage and retrieval of information against the database object(s). Application platform 518 may be a framework that allows the applications of system 516 to run, such as the hardware and/or software, e.g., the operating system. In an embodiment, on-demand database system 516 may include an application platform 518 that enables creation, managing and executing one or more applications developed by the provider of the on-demand database system, users accessing the on-demand database system via user systems 512, or third party application developers accessing the on-demand database system via user systems 512.

The users of user systems 512 may differ in their respective capacities, and the capacity of a particular user system 512 might be entirely determined by permissions (permission levels) for the current user. For example, where a salesperson is using a particular user system 512 to interact with system 516, that user system has the capacities allotted to that salesperson. However, while an administrator is using that user system to interact with system 516, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 514 is any network or combination of networks of devices that communicate with one another. For example, network 514 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 512 might communicate with system 516 using TCP/IP and, at a higher network level, use other common Internet protocols to communicate, such as HTTP, FTP, AFS, WAP, etc. In an example where HTTP is used, user system 512 might include an HTTP client commonly referred to as a “browser” for sending and receiving HTTP messages to and from an HTTP server at system 516. Such an HTTP server might be implemented as the sole network interface between system 516 and network 514, but other techniques might be used as well or instead. In some implementations, the interface between system 516 and network 514 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 516, shown in FIG. 5, implements a web-based customer relationship management (CRM) system. For example, in one embodiment, system 516 includes application servers configured to implement and execute CRM software applications as well as provide related data, code, forms, webpages and other information to and from user systems 512 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 516 implements applications other than, or in addition to, a CRM application. For example, system 516 may provide tenant access to multiple hosted (standard and custom) applications, including a CRM application. User (or third party developer) applications, which may or may not include CRM, may be supported by the application platform 518, which manages creation, storage of the applications into one or more database objects and executing of the applications in a virtual machine in the process space of the system 516.

One arrangement for elements of system 516 is shown in FIG. 5, including a network interface 520, application platform 518, tenant data storage 522 for tenant data 523, system data storage 524 for system data 525 accessible to system 516 and possibly multiple tenants, program code 526 for implementing various functions of system 516, and a process space 528 for executing MTS system processes and tenant-specific processes, such as running applications as part of an application hosting service. Additional processes that may execute on system 516 include database indexing processes.

Several elements in the system shown in FIG. 5 include conventional, well-known elements that are explained only briefly here. For example, each user system 512 could include a desktop personal computer, workstation, laptop, PDA, cell phone, or any wireless access protocol (WAP) enabled device or any other computing device capable of interfacing directly or indirectly to the Internet or other network connection. User system 512 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 512 to access, process and view information, pages and applications available to it from system 516 over network 514. Each user system 512 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 516 or other systems or servers. For example, the user interface device can be used to access data and applications hosted by system 516, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 512 and all of its components are operator configurable using applications, such as a browser, including computer code run using a central processing unit such as an Intel Pentium® processor or the like. Similarly, system 516 (and additional instances of an MTS, where more than one is present) and all of their components might be operator configurable using application(s) including computer code to run using a central processing unit such as processor system 517, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 516 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used, (Javami is a trademark of Sun Microsystems, Inc.).

According to one embodiment, each system 516 is configured to provide webpages, forms, applications, data and media content to user (client) systems 512 to support the access by user systems 512 as tenants of system 516. As such, system 516 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 6 also illustrates environment 510. However, in FIG. 6 elements of system 516 and various interconnections in an embodiment are further illustrated. FIG. 6 shows that user system 512 may include processor system 512A, memory system 512B, input system 512C, and output system 512D. FIG. 6 shows network 514 and system 516. FIG. 6 also shows that system 516 may include tenant data storage 522, tenant data 523, system data storage 524, system data 525, User Interface (UI) 630, Application Program Interface (API) 632, PL/SOQL 634, save routines 636, application setup mechanism 638, applications servers 600₁-600_{N}, system process space 602, tenant process spaces 604, tenant management process space 610, tenant storage area 612, user storage 614, and application metadata 616. In other embodiments, environment 510 may not have the same elements as those listed above and/or may have other elements instead of, or in addition to, those listed above.

User system 512, network 514, system 516, tenant data storage 522, and system data storage 524 were discussed above in FIG. 5. Regarding user system 512, processor system 512A may be any combination of one or more processors. Memory system 512B may be any combination of one or more memory devices, short term, and/or long term memory. Input system 512C may be any combination of input devices, such as one or more keyboards, mice, trackballs, scanners, cameras, and/or interfaces to networks. Output system 512D may be any combination of output devices, such as one or more monitors, printers, and/or interfaces to networks. As shown by FIG. 6, system 516 may include a network interface 520 (of FIG. 5) implemented as a set of HTTP application servers 600, an application platform 518, tenant data storage 522, and system data storage 524. Also shown is system process space 602, including individual tenant process spaces 604 and a tenant management process space 610. Each application server 600 may be configured to tenant data storage 522 and the tenant data 523 therein, and system data storage 524 and the system data 525 therein to serve requests of user systems 512. The tenant data 523 might be divided into individual tenant storage areas 612, which can be either a physical arrangement and/or a logical arrangement of data. Within each tenant storage area 612, user storage 614 and application metadata 616 might be similarly allocated for each user. For example, a copy of a user's most recently used (MRU) items might be stored to user storage 614. Similarly, a copy of MRU items for an entire organization that is a tenant might be stored to tenant storage area 612. A UI 630 provides a user interface and an API 632 provides an application programmer interface to system 516 resident processes to users and/or developers at user systems 512. The tenant data and the system data may be stored in various databases, such as one or more Oracle™ databases.

Application platform 518 includes an application setup mechanism 638 that supports application developers' creation and management of applications, which may be saved as metadata into tenant data storage 522 by save routines 636 for execution by subscribers as one or more tenant process spaces 604 managed by tenant management process 610 for example. Invocations to such applications may be coded using PL/SOQL 634 that provides a programming language style interface extension to API 632. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 616 for the subscriber making the invocation and executing the metadata as an application in a virtual machine.

Each application server 600 may be communicably coupled to database systems, e.g., having access to system data 525 and tenant data 523, via a different network connection. For example, one application server 600₁ might be coupled via the network 514 (e.g., the Internet), another application server 600_{N-1} might be coupled via a direct network link, and another application server 600_{N} might be coupled by yet a different network connection. Transfer Control Protocol and Internet Protocol (TCP/IP) are typical protocols for communicating between application servers 600 and the database system. However, it will be apparent to one skilled in the art that other transport protocols may be used to optimize the system depending on the network interconnect used.

In certain embodiments, each application server 600 is configured to handle requests for any user associated with any organization that is a tenant. Because it is desirable to be able to add and remove application servers from the server pool at any time for any reason, there is preferably no server affinity for a user and/or organization to a specific application server 600. In one embodiment, therefore, an interface system implementing a load balancing function (e.g., an F5 Big-IP load balancer is communicably coupled between the application servers 600 and the user systems 512 to distribute requests to the application servers 600. In one embodiment, the load balancer uses a least connections algorithm to route user requests to the application servers 600. Other examples of load balancing algorithms, such as round robin and observed response time, also can be used. For example, in certain embodiments, three consecutive requests from the same user could hit three different application servers 600, and three requests from different users could hit the same application server 600. In this manner, system 516 is multi-tenant, wherein system 516 handles storage of, and access to, different objects, data and applications across disparate users and organizations.

As an example of storage, one tenant might be a company that employs a sales force where each salesperson uses system 516 to manage their sales process. Thus, a user might maintain contact data, leads data, customer follow-up data, performance data, goals and progress data, etc., all applicable to that user's personal sales process (e.g., in tenant data storage 522). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 516 that are allocated at the tenant level while other data structures might be managed at the user level. Because an MTS might support multiple tenants including possible competitors, the MTS should have security protocols that keep data, applications, and application use separate. Also, because many tenants may opt for access to an NITS rather than maintain their own system, redundancy, up-time, and backup are additional functions that may be implemented in the MTS. In addition to user-specific data and tenant specific data, system 516 might also maintain system level data usable by multiple tenants or other data. Such system level data might include industry reports, news, postings, and the like that are sharable among tenants.

In certain embodiments, user systems 512 (which may be client systems) communicate with application servers 600 to request and update system-level and tenant-level data from system 516 that may require sending one or more queries to tenant data storage 522 and/or system data storage 524. System 516 (e.g., an application server 600 in system 516) automatically generates one or more SQL statements (e.g., one or more SQL queries) that are designed to access the desired information. System data storage 524 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product embodied on a tangible computer readable medium, comprising:
computer code for identifying a record from a first source;
computer code for identifying a first aspect of the record from the first source;
computer code for matching the first aspect of the record from the first source with a first aspect of a record from an on-demand database system;
computer code for identifying a second aspect of the record from the first source;
computer code for matching the second aspect of the record from the first source with a second aspect of the record from the on-demand database system; and
computer code for associating the record from the first source with the record from the on-demand database system, based on the matching of the first aspect and the matching of the second aspect.

2. The computer program product of claim 1, wherein the first source includes a personal information manager application.

3. The computer program product of claim 1, wherein the record includes a contact.

4. The computer program product of claim 1, wherein the computer program product is operable such that the record is identified as the result of an attempt to synchronize the first source with an on-demand database system.

5. The computer program product of claim 1, wherein the first aspect includes an electronic mail address associated with the record.

6. The computer program product of claim 1, wherein the computer program product is operable such that matching the first aspect of the record from the first source with the first aspect of the record from the on-demand database system includes comparing the first aspect of the record from the first source against a plurality of aspects of a plurality of records from the on-demand database system, and determining whether one or more matches are found.

7. The computer program product of claim 1, wherein the computer program product is operable such that the matching is performed using pre-defined matching criteria.

8. The computer program product of claim 7, wherein the computer program product is operable such that the criteria are determined by the on-demand database system.

9. The computer program product of claim 7, wherein the computer program product is operable such that the criteria are determined by a user.

10. The computer program product of claim 1, wherein the computer program product is operable such that matching the first aspect of the record from the first source with the first aspect of the record from an on-demand database system results in a single match, a plurality of matches, or no matches.

11. The computer program product of claim 1, wherein the computer program product is operable such that associating the record from the first source with the record from the on-demand database system includes linking the record from the first source to the record from the on-demand database system based on the matching of the first aspect and the matching of the second aspect.

12. The computer program product of claim 1, wherein the computer program product is operable such that the record from the on-demand database system is associated with an account of the on-demand database system.

13. The computer program product of claim 1, wherein the computer program product is operable such that if matching the first aspect of the record from the first source with the first aspect of the record from the on-demand database system results in a single match, the record from the first source is automatically associated with the account from the on-demand database system, based on the matching of the first aspect.

14. The computer program product of claim 1, wherein the computer program product is operable such that if matching the first aspect of the record and matching the second aspect of the record results in no matches, a new record is created in the on-demand database system.

15. The computer program product of claim 14, wherein the computer program product is operable such that the new record is associated with the record from the first source.

16. The computer program product of claim 14, wherein the computer am product is operable such that the new record is created automatically.

17. The computer program product of claim 14, wherein the computer program product is operable such that the record from the first source is added to an unresolved items queue, and a user accesses the queue and manually creates the new record.

18. The computer program product of claim 1, wherein the computer program product is operable such that the first aspect and the second aspect are determined by a user.

19. A method, comprising:
identifying a record from a first source;
identifying a first aspect of the record from the first source;
matching the first aspect of the record from the first source with a first aspect of a record from an on-demand database system;
identifying a second aspect of the record from the first source;
matching the second aspect of the record from the first source with second aspect of the record from the on-demand database system; and
associating the record from the first source with the record from the on-demand database system, based on the matching of the first aspect and the matching of the second aspect.

20. An apparatus, comprising:
a processor for:
identifying a record from a first source;
identifying a first aspect of the record from the first source;
matching the first aspect of the record from the first source with a first aspect of a record from an on-demand database system;
identifying a second aspect of the record from the first source:
matching the second aspect of the record from the first source with a second aspect of the record from the on-demand database system; and
associating the record from the first source with the record from the on-demand database system, based on the matching of the first aspect and the matching of the second aspect.

21. A method for transmitting code for use multi-tenant database system on a transmission medium, the method comprising:
transmitting code for identifying a record from a first source;
transmitting code for identifying a first aspect of the record from the first source;
transmitting code for matching the first aspect of the record from the first source with a first aspect of a record from an on-demand database system;
transmitting code for identifying a second aspect of the record from the first source;
transmitting code for matching the second aspect of the record from the first source with a second aspect of the record from the on-demand database system; and
transmitting code for associating the record from the first source with the record from the on-demand database system, based on the matching of the first aspect and the matching of the second aspect.
